(19) United States
(12) Patent Application Publication
(10) Pub. No.: US 2002/0117818 A1
(43) Pub. Date: Aug. 29, 2002

(54) Transportable grain and vitamin holder

(76) Inventors: Catherine A. Barnes, Morgan, UT (US); John M. Rhineer, Morgan, UT (US)

Correspondence Address: Richard C. Litman, LITMAN LAW OFFICES, LTD., P.O. Box 15035, Arlington, VA, 22215, US

(21) Appl. No.: 10/082,172

(22) Filed: Feb. 26, 2002

Related U.S. Application Data
(60) Provisional application No. 60/271,729, filed on Feb. 28, 2001.

(51) Int. Cl. B62B 1/24

(52) U.S. Cl. 280/47.26

(57) ABSTRACT

A transportable feed grain and vitamin holder for livestock, especially horses, includes a compartmented container unit adapted to be supported on the open top of a conventional stable cart. Two compartments of the container unit are designed to hold dry fee grain or pellets. Other compartments hold dry vitamins. At leas one compartment holds a liquid vitamin. A hand operated pump is provided to dispense the liquid vitamin.

### CROSS-REFERENCE TO RELATED APPLICATION

This application claims the benefit of U.S. Provisional patent application Ser. No. 60/271,729, filed Feb. 28, 2001.

### BACKGROUND OF THE INVENTION

1. Field of the Invention

The present invention generally relates to wheeled vehicles. More specifically, the present invention is drawn to a mobile cart for use in feeding horses or livestock.

2. Description of the Related Art

The daily process of properly feeding livestock, particularly horses, usually requires mixing the grain ration and vitamin dosage at the grain area and carrying the mixture to the particular horse's stall. This scenario must be repeated for each horse. It is obvious that at stables with many horses, the aforementioned task can become a time-consuming drudgery. An invention that would alleviate some of the repetitive functions in the process, and consequently save time, would certainly be a welcome addition in the horse and livestock feeding art.

There are many portable apparatus utilized for feeding livestock. Usually the prior art apparatus include a feed container, mounted on wheels or skids, which container is filled with grain and towed to an area where all livestock may have access. An example of the prior art apparatus is disclosed in U.S. Pat. No. 5,237,962 (Garman). The Garman apparatus makes no provision for mixing vitamins with the feed, nor is there any means for feeding each animal a pre-determined ration of feed.

U.S. Pat. Nos. Des. 302,888 (Jung) and Des. 345,839 (Senese) respectively show mobile carts for transporting food and ice. Both carts are designed to supply products for human consumption. The feeding of livestock does not appear to be contemplated.

U.S. Pat. No. Des. 311,621 (Fuller) discloses a cart designed to be utilized in stables. No provision is made for transporting separated quantities of feed and vitamins in the cart.

U.S. Pat. Nos. Des. 389,972 (Grosfillex), 5,484,160 (Ek) and 5,615,903 (Spear et al.) show portable carts designed for gardening and/or lawn care use. The instant carts have no provision for transporting separated quantities of livestock feed and vitamins.

None of the above inventions and patents, taken either singly or in combination, is seen to disclose livestock feeding apparatus as will be subsequently described and claimed in the instant invention.

### SUMMARY OF THE INVENTION

The present invention comprises a container unit designed to fit onto the top of commonly used stable carts such as that as shown in U.S. Pat. Des. No. 311,621 (Fuller). The container unit is compartmented such that a quantity of feed and liquid and dry vitamins may be transported in separated fashion. The container is equipped with handles so that it may easily be inserted and removed from the stable cart. The container is also provided with L-shaped front and rear ends which, along with the handles, function to securely support the container unit form the walls of the stable cart. A lid is provided for each compartment to prevent unwanted livestock intrusion. If desired, each lid may be marked as to the respective compartment's contents. At least one compartment is equipped with a pump to facilitate the dispensing of liquids. A scoop is provided for measuring out the required ration of the dry feed and/or dry vitamin products. The container unit of the instant invention allows a user fill the container with feed and vitamins at the grain area and proceed down the aisle of the stable to feed and dose each animal from the container unit without walking back and forth to the grain area.

Accordingly, it is a principal object of the invention to provide a container unit, which container unit is utilized t transport feed and vitamins to be meted out to livestock.

It is another object of the invention to provide a container unit for transporting feed and vitamins to livestock, which container unit is provided with plural compartments.

It is a further object of the invention to provide a container unit for transporting feed and vitamins to livestock, which container unit can be easily supported on and removed from a conventional stable cart.

Still another object of the invention is to provide container unit, which container unit is equipped with liquid dispenser structure.

It is an object of the invention to provide improved elements and arrangements thereof in an apparatus for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a transportable grain and vitamin holder according to the present invention.

FIG. 2 is a top view of a transportable grain and vitamin holder according to the present invention.

FIG. 3 is an exploded, perspective view of a transportable grain and vitamin holder according to the present invention.

Similar reference characters denote corresponding features consistently throughout the attached drawings.

### DETAILED DESCRIPTION OF THE PREFERRED EMBODIMENT

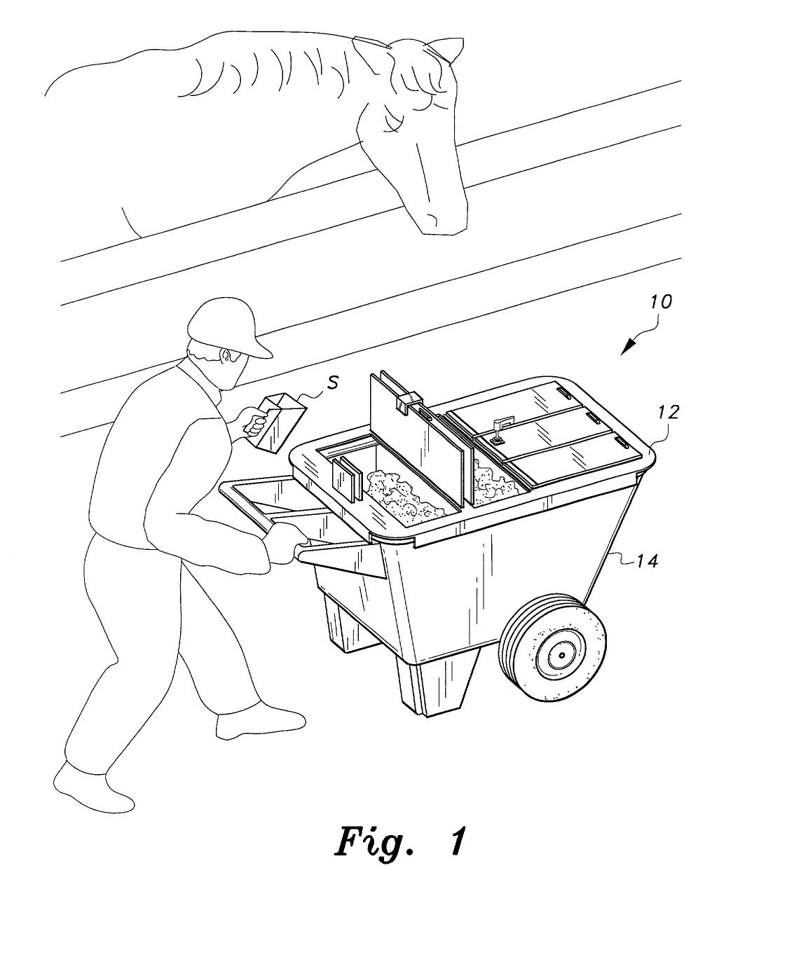

The present invention, as generally shown at 10 in FIG. 1, comprises a container unit 12 dimensioned to be supported in a wheeled stable cart 14. As noted above, stable cart 14 is of a popular type commonly used at horse ranches and horse shows. It is obvious that container unit 12 could be adapted to fit other carts if desired. Stable cart 14 is not, per se, part of the inventive concept.

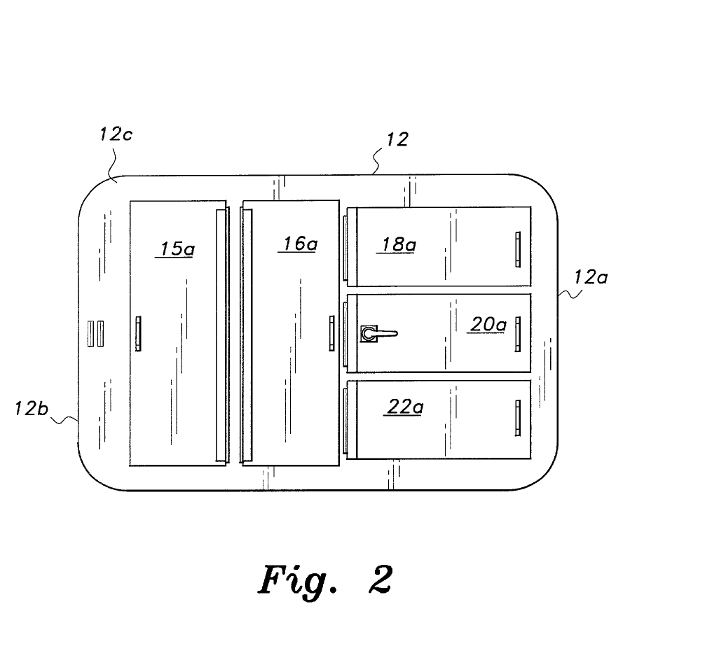

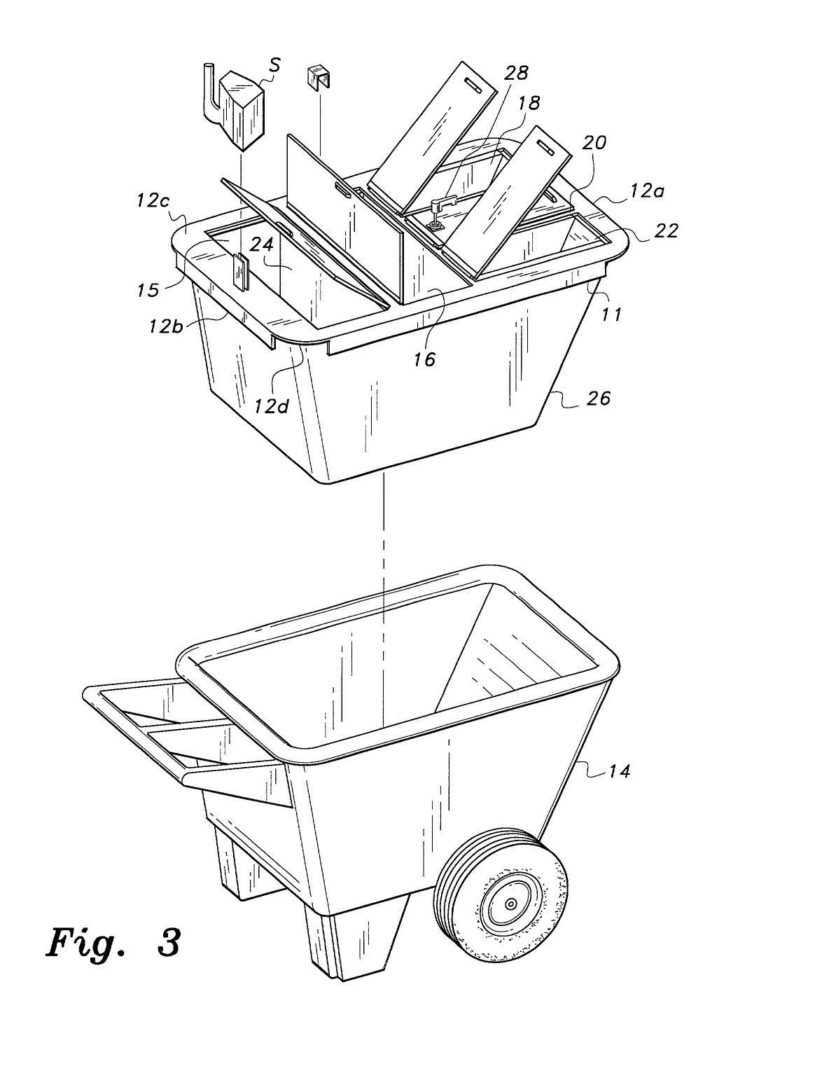

Attention is now directed to FIGS. 2 and 3 which best illustrate the structural arrangement of container unit 12. As presently contemplated, container unit 12 will be fabricated from durable plastic material (a suitable metal may also be used) Container unit 12 is of rectangular configuration having a forward, L-shaped end 12a, a rear L-shaped end 12b and generally planar upper and lower faces 12c and 12d. Two relatively large openings 15, 16 are formed in the container adjacent rear end 12b. At least three smaller openings 18, 20, 22 are formed in the container adjacent forward end 12a. Each opening is provided with a respective, movable lid 15a, 16a, 18a, 20a and 22a. A thin wall separation member 24 extends vertically downward from lower face 12d, forming separate bins beneath lids 15a and 16a, to form two separated volumes in the cart, each volume adapted to contain dry livestock feed such as grain or pellets.

An imperforate housing 26 is formed beneath the upper surface and lids, and is configured such that housing 26 will nest within the walls of stable cart when the container is positioned in the cart. At least three additional and separate, open-top compartments are formed in housing 26. The open tops of the compartments coincide with respective openings 18, 20, and 22. The outer compartments are designed to contain dry vitamins for livestock. The central compartment contains vitamins in liquid form. It is apparent that the contents of the compartments may vary as needed. A hand-operated pump 28 is provided to dispense the liquid vitamins from the central compartment.

The sides of container 12 are fashioned as handles 11 (only one side shown) to enhance manipulation of the container. The handles 11 and L-shaped ends 12a, 12b function to provide secure support when the container is disposed onto stable cart 14. A scoop S is removably attached to the rear 12b, which scoop is utilized to provide the proper amount of dry feed and/or vitamins to each horse or other livestock animal.

Although the container of the instant invention, in its preferred embodiment, is described as a separate structure adapted to be utilized with a known cart, it is obvious that the cart and container could form a single unitary structure. Alternatively, the two compartments formed by the vertical wall 24 could be totally open, with the side walls of the cart 14 forming the remainder of the compartments. In the present, preferred embodiment, the structure is self-contained, thereby making the container more adaptable for use with different cart styles.

It is to be understood that the present invention is not limited to the sole embodiment described above, but may encompasses any and all embodiments within the scope of the following claims.

We claim:

1. A removable grain and vitamin holder adapted to be supported in an open receptacle comprising:
a container unit, said container unit having a forward end, a rear end, two sides, a substantially planar upper surface and a substantially planar lower surface;
a pair of relatively large openings disposed through said upper surface and said lower surface, said large openings positioned adjacent said rear end of said container;
at least three smaller openings disposed through said upper surface and said lower surface, said smaller openings positioned adjacent said forward end of said container;
structure at said rear end, said forward end and said two sides for securely supporting said container unit in the open receptacle.

2. A removable grain and vitamin holder as recited in claim 1, including a dividing wall;
said dividing wall disposed on said lower surface and extending vertically downward therefrom between said pair of relatively large openings.

3. A removable grain and vitamin holder as recited in claim 2, including at least three compartments disposed on said lower surface and positioned adjacent said forward end.

4. A removable grain and vitamin holder as recited in claim 3, wherein each of said at least three compartments is positioned under a respective one of said at least three smaller openings.

5. A removable grain and vitamin holder as recited in claim 4, including a plurality of hinged lids disposed on said upper surface, a respective one of said plurality of lids covering a respective one of said pair of relative large openings and said at least three smaller openings.

6. A removable grain and vitamin holder as recited in claim 5, wherein each said at least three compartments has an open top and imperforate side and bottom walls.

7. A removable grain and vitamin holder as recited in claim 6, including a liquid pump communicating with one of said at least three compartments.

8. A removable grain and vitamin holder as recited in claim 7, including a grain scoop removably attached to said upper surface.

9. A removable grain and vitamin holder as recited in claim 8, wherein said container unit is fabricated from a plastic material.

10. The combination of a wheeled cart and a removable grain and vitamin holder, said wheeled cart having a bottom wall, two end walls, two side walls and an open top defining an unobstructed volume, said removable grain and vitamin holder comprising:
a container unit, said container unit having a forward end, a rear end, two sides, a substantially planar upper surface and a substantially planar lower surface;
a pair of relatively large openings disposed through said upper surface and said lower surface, said large openings positioned adjacent said rear end of said container;
at least three smaller openings disposed through said upper surface and said lower surface, said smaller openings positioned adjacent said forward end of said container;
structure at said rear end, said forward end and said two sides for securely supporting said container unit in nesting fashion, in said open top of said wheeled cart.

11. The combination of a wheeled cart and a removable grain and vitamin holder as recited in claim 10, including a dividing wall;
said dividing wall disposed on said lower surface and extending vertically downward therefrom between said pair of relatively large openings.

12. The combination of a wheeled cart and a removable grain and vitamin holder as recited in claim 11, including at least three compartments disposed on said lower surface and positioned adjacent said forward end.

13. The combination of a wheeled cart and a removable grain and vitamin holder as recited in claim 12, wherein each of said at least three compartments is positioned under a respective one of said at least three smaller openings.

14. The combination of a wheeled cart and a removable grain and vitamin holder as recited in claim 13, including a plurality of hinged lids disposed on said upper surface, a respective one of said plurality of lids covering a respective one of said pair of relative large openings and said at least three smaller openings.

15. The combination of a wheeled cart and a removable grain and vitamin holder as recited in claim 14, wherein each said at least three compartments has an open top and imperforate side and bottom walls.

16. The combination of a wheeled cart and a removable grain and vitamin holder as recited in claim 15, including a liquid pump communicating with one of said at least three compartments.

17. The combination of a wheeled cart and a removable grain and vitamin holder as recited in claim 16, including a grain scoop removably attached to said upper surface.

18. The combination of a wheeled cart and a removable grain and vitamin holder as recited in claim 17, wherein said container unit is fabricated from a plastic material.
